(19) United States
(12) Patent Application Publication
(10) Pub. No.: US 2025/0335484 A1
(43) Pub. Date: Oct. 30, 2025

(54) TOKENIZED TEXT FOR EFFICIENT SEARCHING BY MACHINE LEARNING (ML) APPLICATIONS

(71) Applicant: Anacode Labs Inc, Castro Valley, CA (US)

(72) Inventors: Michael Roberts, Los Gatos, CA (US); Albert Wegener, Castro Valley, CA (US)

(73) Assignee: Anacode Labs Inc, Castro Valley, CA (US)

(21) Appl. No.: 19/207,257

(22) Filed: May 13, 2025

Related U.S. Application Data
(63) Continuation-in-part of application No. 19/192,180, filed on Apr. 28, 2025.
(60) Provisional application No. 63/639,536, filed on Apr. 26, 2024.
(60) Provisional application No. 63/646,634, filed on May 13, 2024.

(51) Int. Cl. G06F 16/334; G06F 16/335

(52) U.S. Cl. CPC G06F 16/3344; G06F 16/335

(57) ABSTRACT

A database of tokenized data is provided. The tokenized database has been trained with a chunk of original text with words that have been compressed with tokens corresponding to the words. The text chunk is assigned a chunkID and at least some of the words are assigned a tokenID. The tokenized database can be filtered based on the tokenIDs for the one or more tokenized words from a search query. Each tokenID exposes a list of blocksIDs. A chunk of original text corresponds to each of the chunkIDs. The one or more sentences are compared to each sentence of the list of tokenized sentences to rank sentences.

### CROSS-REFERENCE TO RELATED APPLICATIONS

This application claims the benefit of priority under 35 USC 120(a) as a continuation in part to U.S. application Ser. No. 19/192,180, filed Apr. 28, 1925, by Wegener et al., which in turn claims priority under 35 USC 119(e) to U.S. App 63/639,536, filed Apr. 26, 2024, by Roberts et al. and to U.S. App 63/646,634, filed May 13, 2024, by Roberts et al., the contents of each being hereby incorporated by reference in their entirety.

### FIELD OF THE INVENTION

The invention relates generally to computers and artificial intelligence (AI), and more specifically, to tokenizing text for efficient searching by machine learning (ML) applications.

### BACKGROUND

Recent years have seen the development of a variety of ML and AI technologies based on Large Language Models (LLMs). These technologies have found a variety of applications, including natural language processing, text/voice chat, and human-robot communications.

ChatGPT is one exemplar of this strand of technology. Such systems are typically based on the transformer model of AI, which processes data by tokenizing the input and performing (largely mathematical) operations to discover inter-token relationships, thus training a model which encodes some of the properties of the input. Systems trained using such techniques typically use attention models, which enable the transformer model to see different parts of the sequence of tokens, the context in which a sentence exists (whether temporal, or in a larger document), and other related properties.

Complete AI systems are often composed of multiple neural network layers, including recurrent, feedforward, embedding and attention layers. Input training data for these systems frequently uses very large databases of plain text, which is suitable for compression in the conventional sense. Many other variants of the transformer model exist; the generative AI approach is an exemplar that enables the “creation” of content based on prompts that we particularly wish to draw attention to.

However, content or responses generated by such applications, while applicable for many uses, can contain hallucinations of facts. Hallucinations are beliefs or output sentences that are generated based on input to the model which have little, or no, grounding in the original input data. They can result from insufficient training data leading to an averaging which takes place when the model assumes certain elements which seem to be common to different items in the training database. There can also be deliberate sabotage to data.

Although the process leading up to the generation of an actual specific hallucination is complex, resolution of such issues often require ad-hoc access to small pieces of the original text, so that the veracity of the output from the ML system can be compared with actual, real, data and not generated from aggregate properties which are discovered from analysis of the original material, yet necessarily do not contain all of the information contained in that material. This process can occur during training, or at other times, while the system is deployed.

It is clearly not currently practical for any trained system to contain a representation of all the training data in the memory of a single computer, especially when deployed at the network edge. In any case, the process of training itself is by definition the process of establishing more distilled relationships between tokens and concepts. In such a process, some of the original information is invariably abstracted or lost in translation.

Therefore, what is needed is a robust technique for tokenizing text for efficient searching by ML applications.

### SUMMARY

These shortcomings are addressed by the present disclosure of methods, computer program products, and systems for tokenizing text for efficient searching by ML applications.

In one embodiment, a database of tokenized data is provided. The tokenized database has been trained with a chunk of original text with words that have been compressed with tokens corresponding to the words. The text chunk is indexed by assigning a chunkID and at least some of the words are indexed by assigning a tokenID.

In another embodiment, one or more sentences are received from an ML source, and one or more words are determined from the one or more sentences to use for querying the tokenized database. TokenIDs are identified from a database of tokenIDs corresponding to the blockIDs for the one or more words from the one or more sentences. The tokenID database associates a list of blockIDs to tokenIDs of words using a fixed number of bytes. TokenIDs are limited in number based on the fixed number of bytes and assigned based at least in part on frequency of use.

The tokenized database can be filtered based on the tokenIDs for the one or more tokenized words from the search query. Each tokenID exposes a list of blocksIDs. A chunk of original text corresponding to each of the chunkIDs. The one or more sentences are compared to each sentence of the list of tokenized sentences to rank sentences.

Based on the output, a reply can be sent back to the ML source, including at least a top ranking of the one or more sentences.

Advantageously, AI and ML systems can efficiently retrieve raw data for analysis.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level illustration of a system for real-time identification of fact hallucinations in query results produced by AI, according to an embodiment.

FIG. 2A is a more detailed illustration of an AI verification server of the system of FIG. 1, according to an embodiment.

FIG. 2B is a more detailed illustration of a fact database of the system of FIG. 1, according to an embodiment.

FIG. 3 is a high-level flow diagram illustrating a method for quality control for AI systems, according to an embodiment.

FIGS. 4A-4D are sequence diagrams illustrating tokenizing of a database, according to an embodiment.

FIG. 5 is a more detailed flow diagram illustrating the step of using tokenized indexes for real-time identification of fact hallucinations in query results produced by AI, for the method of FIG. 3, according to one embodiment.

FIG. 6 is a sequence diagram illustrating generation of sentences for comparison, according to an embodiment.

FIG. 7 is an example of a computing environment for implementing components of the system of FIG. 1, according to an embodiment.

FIG. 8 is a more detailed flow diagram illustrating the step of comparing sentences, according to an embodiment.

### DETAILED DESCRIPTION

The description below provides methods, computer program products, and systems for tokenizing text for efficient searching by ML applications.

One of ordinary skill in the art will recognize many additional variations made possible by the succinct description of techniques below. For example, tokenized databases are described herein mainly within implementations of AI query validation, although there are numerous other implementations for other AI and ML processes.

### I. Tokenized Database in Systems for Identifying Fact Hallucinations

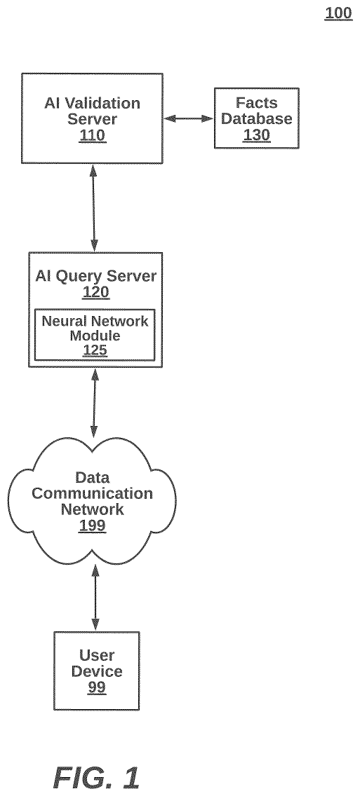

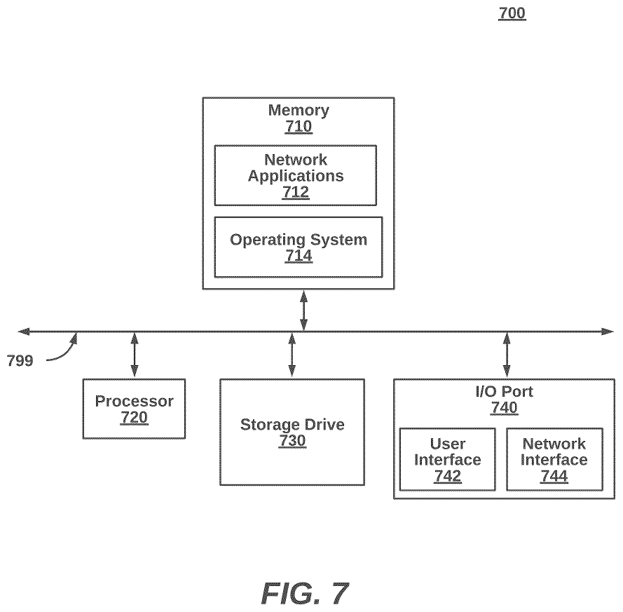

FIG. 1 is a high-level illustration of a system 100 for real-time identification of fact hallucinations in query results produced by AI, according to an embodiment. The system 100 includes an AI validation server 110, and an AI query server 120 and a fact database 130, each communicatively coupled to a data communication network 199. Many other embodiments are possible, for example, more or fewer access points, more or fewer stations, and additional components, such as firewalls, routers and switches. The system 100 components can be located locally on a LAN or include remote cloud-based devices, and can be implemented in hardware, software, or a combination similar to the example of FIG. 7.

The components of system 100 are coupled in communication over a data communication network 199. Preferably, AI validation server 110, AI query server 120 and fact database 130 are connected to the data communication system 199 via hard wire. Other components, such as Wi-Fi stations and IoT devices can be connected indirectly via wireless connection. The Internet 199 can be any data communication network such as a WAN, a LAN, WLAN, a cellular network (e.g., 3G, 4G, 5G or 6G), or a hybrid of different types of networks. Various data protocols can dictate format for the data packets.

The AI validation server 110 determines when AI query responses potentially include fact hallucinations. As a result, inaccurate data is avoided and fact database 130 can correct itself. In one example, a user queries AI server 120 about living, pink colored groundhogs. One data set in fact database 130 can be indicative of live groundhog colors, without confirming or denying the existence of pink groundhogs. Another data set in fact database 130 can be indicative of pink colored groundhog candy. Problematically, the AI query server 120 may respond to the query with a fact hallucination referring to pink groundhog candy. Instead, AI validation server 110 runs a check on the underlying facts to identify the inaccuracy. Based on implementation rules, a remediation action can occur when inaccuracies are discovered, such as responding to the query as answer unknown, insufficient data, or the like.

The AI query server 120 can be a search engine, a smartphone app, a voice assistant, a robot, or any appropriate interface for making AI queries and receiving a response. A third party can operate AI query server 120 as a subscription-based software-as-a-service over the Internet. Query processing can occur in a neural network module 125 trained from fact database 130 or other resources. The training uses deep learning to process raw data through interconnected nodes in a layered structure. One implementation trains AI query server 120 with fact database 130, so AI output can be checked against original documents used to derive AI output. In one embodiment, AI validation server 110 and AI query server 120 are housed in a common physical device, and in another embodiment, are in communication over the Internet. In a similar manner, a user submitting questions can be directly speaking to AI query server 120, and alternatively, can submit queries over the Internet.

In operation, AI queries are submitted in real-time or in batch under various scenarios. For example, human users can submit queries to an online AI service to answer general questions. In another example, a search engine process may submit search results for generating an AI summary to display along with the returned search results. In yet another example, a robot device may be searching for actions to take responsive to current sensory input.

Fact database 130 can be one or more data resources of tokenized data, such as database or other repository. Data can be drawn from various resources on the Internet, such search engines, directories, Wikipedia, government public data, documents, and the like. A crawler tokenizes raw text, using various techniques, and indexes. In one embodiment, AI query server 120 generates an AI response by processing a search of tokens. Before releasing the result, AI validation server 120 calculates a veracity score by searching fact database 130 for tokens related to the AI response for comparison. In other implementations, the veracity score is derived from comparison of the AI response from fact database 130 and fact checking from a different, second fact database.

### A. Fact Database Tokenization

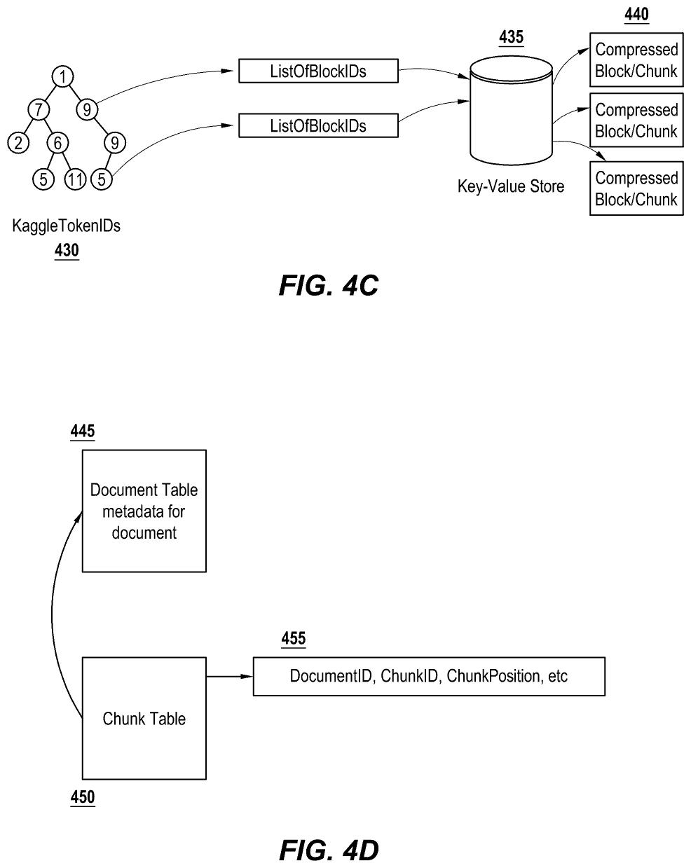

Details for indexing tokens of the fact database during training are shown in FIGS. 4A-4D.

Word tokenization in conventional compression is the process of replacing words in an input stream with tokens, which can be reused when the word is next seen. The size of the output stream is thus reduced, with the token acting as a “stand in” for the original word. Given that words typically appear multiple times in documents, and providing tokens of appropriate bit-length length are selected, this can result in the output stream being considerably smaller (for the purpose of transmission or storage) than the original input stream.

Similarly, Byte-Pair encoding (BPE) can be used to encode the most frequent byte pairs in a text for alternate or additional size savings. The BPE technique is considered useful in ML for languages which combine smaller linguistic units together into words. Word-based tokenization is more suitable to western style languages, such as English. It is also used in conventional compression.

Once tokenized, ML techniques can then additionally discover relationships between the occurrences of tokens and encode this information in the neural network, using a variety of approaches. A slightly different, and more traditional, domain—conventional or information compression—specifically, in our topic of interest, across textual information. Using this technique, file sizes typically shrink by significant factors.

Being block-based, each block output from the compressor contains a separate index of token information for the block. Using this block, and a stream of tokens, a decompressor can reconstruct the original text from the compressed data. One advantage to this block-based approach is that compression of the individual blocks can essentially happen independently, and in parallel. Each block is essentially a self-contained compressed part of the original input.

Token bit lengths and actual values are computed based on frequency of use calculations. Tokens with high usage frequencies (such as, for example, the word “the” in many English language texts) are replaced with very short tokens with bit-lengths as low as 2 bits. Less frequently used words (such as “fabulous”) are replaced with longer token lengths.

The actual words for the tokens can be written in the block header or index, along with the assigned token. Using a memorized version of this index, when the decompressor reads bits from the compressed block, it can use the index to figure out what word to replace the token within the output stream. Without intending loss of generality, and for an abundance of clarity, we describe only the process for English word tokens, noting that the byte-pair process is almost identical, and a variant of this approach, and this application should be obvious to a reader skilled in the art.

In one version of the Kaggle dataset, each word is represented by a 3 byte tokenID, which provides for a total of 16,777,216 possible tokens, of which we are currently using 333,333 for Kaggle words, global token IDs or KaggleTokenIDs. This leaves 16,442,882 unused tokens (a variant of this scheme would be to use 16-bits worth of tokens—65 k tokens, but this space does not contain all the Kaggle words).

It should be stated that the token set can be expanded to cover all words in the English language. The OED (Oxford English Dictionary) covers around 600,000 words, well within the 3-byte range. However, the Kaggle words can be used here as a stand-in for this larger set.

A single file, read at initialization time, contains the 333,333 Kaggle words, separated by spaces, in frequency of use order, with the most frequently used word first in the file. This file is ingested by the compressor at startup time.

Note that the Kaggle file contains the vast majority, but not all, of the words which the block compressor might encounter when compressing a block, and that typically, any given block will contain both a subset of the Kaggle words, and also some other words which do not exist in Kaggle, for example, mis-spellings, punctuation marks, words in quotes, or simply words not in Kaggle, etc.

Also note that, since the compressor is typically kept as a hot service for this application, the overhead of reading the initialization data is paid just once at startup time and is generally not significant.

Three hash (or b-tree) tables are constructed to enable interaction with tokens, each of which has a set of keys and a set of values, and a correspondence between tokens and values. In the case of the first hash table 405 shown in FIG. 4A, the key is the KaggleTokenID (0-333,333). The second hash table 410 is built by the compressor and includes the header of each block in a compressed form. It is keyed by a LocalTokenID, the value and bit-length of which is assigned during the compression process and is local to the bock being compressed. The third hash table 415 is keyed by bytes forming the actual words (which vary based on the encoding scheme used).

Initially, this table has keys for just the Kaggle words, but subsequently, after compression has occurred, it also contains any additional words, word fragments, or byte sequences for other tokenized artifacts discovered by the compressor in addition to the known Kaggle words. In this way the compressor does not break if it meets a word outside the Kaggle word set.

The bit length of the tokens can vary, using short bit lengths for very frequent tokens and/or tokens with maximum savings, and using longer tokens are reserved for less frequently used words. The value for all of the hash tables is a small C or C++ struct—the hash tables enable look ups of this struct based on either a byte sequence (for the word), the KaggleTokenID, or via an assigned LocalTokenID.

The contents of this struct are given below (in C++). Although 32-bit tokenIDs are used, note that only 24 bit IDs (3 bytes) are significant, and that in the case of the localTokenID, a much lower number are actually used (for example 2-12 bits). Both the bit length and the tokenID are assigned at block compression time.

The following is an example of microcode of tokenizing:

```
          struct TokenDef {
      // Enumeration describing details for this token
        enum TokenType {
          DWK, // Kaggle dictionary word. Word and wordLen
          define the word DWL, // Dictionary word local (not in
          kaggle). word/wordLen defines word BP, // BytePair. In
          this case wordLen = 2, and word is two bytes
          DBP, // Double BytePair (4 bytes). wordLen = 4, and
          word is 4 bytes
          RUN // Run of chars of length wordLen. In this case,
          word is a single char
        }
      TokenType tokenType; // The type of this token, as per
      enum above uint32_t kaggleTokenID; // the global, or
      “Kaggle” tokenID
      uint32_t localTokenID;  // the local tokenID (up to 24
      bits)
      } uint8_t localTokenIDBitLength; // the length, in bits, of
      the assigned token
      char * word;  // the actual word as a null-terminated
      string
      uint8_t wordLen;  // the length of the word (saves time
      versus strlen( )
}
```

Note that before compression of the block, but after the Kaggle words have been read in, both the localTokenID and localTokenIDBitLength are 0.

After Kaggle words are read in, for a Kaggle word, the word, wordLen, and kaggleTokenID are both initially assigned. In the case of later added tokens which are not present in the Kaggle dictionary, the globalTokenID will be 0, indicating a locally defined word or token.

Regarding token usage, we have two conflicting requirements—to use very small bit-length tokens in compressed files (in order to save space) and yet also to maintain a global set of tokens with stable token IDs (for searching).

Recall that although we store (in memory) tokens as 32-bit uint32_t datatypes, only 3 bytes (24 bits) are potentially used, and for most tokens a lot less than this. These two requirements are rectified by mapping between token spaces which solve both of these problems, separately.

An actual number of bits a token uses can be computed. More frequently used words in the Kaggle word list, like “the” will have a very short bit length KaggleTokenID. This token is of course largely independent of the LocalTokenID used in the compressed data segment, but it does map to this.

An application or service reads compressed blocks and returns a list of KaggleTokenIDs used by that block. These IDs are the interesting IDs for this block—references to words which are in the block and serve as a primitive index for just that block—the words that are contained in the block.

In one embodiment, our dataset is searched for co-occurence of words within given sentences or blocks, as this is a typical useful query for resolving ML questions about sentence usage. In another embodiment, the set of words to search for is not known ahead of time, but that we exclude from this set all common words. Note that these common words, such as “the” have the highest count, and thus the lowest IDs in the space of Kaggle tokens.

A lower bound can be set beneath which words are uninteresting due to a small number of occurrences in the Kaggle training corpus. As a result, any words with KaggleTokenIDs above this bound are interesting and indexed. Words that are beneath the threshold are uninteresting and not indexed.

### 1. Compression

To compress a block, the compressor walks though the bytes in the block-to-be-compressed, performing a variety of operations (not described here) to assign localTokenIDs to words/byte sequences.

If the found word (a sub-type of byte sequence) is in Kaggle, the TokenDef instance referenced by the maps will have a defined kaggleTokenID, and the tokenType will be DWK (DictionaryWordKaggle).

If it is a word, but not found in Kaggle, it will have the token type of DWL (DictionaryWord); a variety of other token types also exist, as defined in the TokenType above; their extraction and use are out of scope for this application, which is mainly focused on the use of this particular technique in a higher level system.

At the end of compression, all tokens will have a localTokenID, and localTokenIDBitLength, assigned by the compressor, which does the best it can at an optimal token assignment, approached in a heuristic manner, as is consistent with the fact that a fully optimal assignment of tokens is in fact a computational hard problem and not perfectly approachable in linear time.

Once localTokenIDs are assigned, a header is formed by compressing only those TokenDefs referenced by the maps which have a non-zero localTokenID and then writing out appropriate information from the struct(s) to enable a decompressor, or other system using a compressed block, to replace a tokenID with the corresponding information from the TokenDef. This header contains, at minimum, a compressed map of local to global tokenIDs as well as information for any other locally defined tokens.

The header 420 is accompanied by a data segment 425 which contains the actual compressed data, a shown in FIG. 4B. The first bytes in the compressed block are a magic number identifying a compressed block, followed by the length of the header, and the length of the data block. The data block contains compressed data—essentially a stream of variable length binary strings which reference LocalTokenIDs defined in the header.

### 2. Decompression

The header information can be read back into the memory of a computing device and, when combined with the information from the Kaggle tokens, a complete set of the 3 maps can be re-established.

To decompress a block, it is then a matter of simply reading through the compressed data segment, and generating an output stream which consists of the corresponding byte sequences from the tokens.

Note that as per the original application, both compression and decompression of separate blocks can happen essentially in parallel on different cores or using a web service, lambda services, or other parallel execution mechanism, yielding faster compression/decompression than would normally occur on a single core.

Operation of the index is shown in FIG. 4C:
1) Maintain an in-memory b-tree (or similar data structure) keyed on the KaggleTokenID 430 for any interesting words which are in the set of stored blocks. A b-tree is selected here due to the memory compactness properties it has and the operation of such is deemed familiar to one skilled in the art. Each leaf node in the tree references a set of block identifiers (meaning that this token is referenced in that block). Each KaggleBlockID is thus essentially a pointer to the actual compressed block 440 (stored in the key-value store 435) that contains the token.
2) Note that multiple leaf nodes in the b-tree can point to the same block; this just means that the block contains multiple different tokens or words. All these words are in that block.
3) Note that there is no requirement for the entire b-tree to be resident in the memory of a single computer; portions of it may reside on a plurality of computers; or on disk to be retrieved as needed via “faulting”, or stored in the key-value store.
4) Provide operations to add a pair Add {KaggleTokenID: BlockID} to the b-tree; also to remove a pair Remove {KaggleTokenID: BlockID}. These operations can be batched for efficiency; the add operation is used when a compressed block is added to the system as follows. Firstly, all interesting words with Kaggle tokenID> threshold at retrieved from the block and then a sequence of AddPair operations are called to index the block into the index. Similarly, when a block is removed, a sequence of RemovePair operations are called.
5) A get operation is provided: Get {list of interesting words in sentence}. First retrieve the set of Kaggle tokenIDs associated with the word or words; then use these tokenIDs to retrieve sets of matching blocks from the b-tree. Finally, we AND these result sets together to find blocks in which the tokens co-occur. Such operations can be performed sequentially or in parallel; we fetch kaggle tokenIDs for each word and perform a set AND operation, as is well known to one skilled in the art. The result set then contains all of the blocks containing a co-occurence of the words. Similarly; we can provide an “input blockID set” to a query; this set contains only blocks we are interested in; any blockIDs not in this set are rejected immediately using this method. Method 6 (below) provides a sequential optimization by essentially combining AND and FETCH operations.
6) Generally, but not exclusively, we are interested in a co-occurence of certain representative words in a sentence. Since words with lower tokenIDs occur less frequently; we can search in the following manner:
   a. Compute the tokenIDs for the interesting words in the sentence.
   b. Sort the tokenIDs; highest tokenIDs should be first; remove any tokenIDs beneath the interest threshold.
   c. Initialize the co-occurence set to be { }

For each tokenID; perform the Get operation, passing in the co-occurence set; storing the resulting set in the co-occurences. In this way, the set is progressively refined until it contains just those blockIDs containing ALL of the words.
7) Note that various combinations of (5) and (6) also exist. Several versions can be computed of (6) simultaneously and combine them via a set AND operation. Note that these methods allow us to trade execution speed against memory foot print. This can be determined dynamically based on loading.
8) Further note that the index can be maintained on a number of machines simultaneously; operations for Add And Remove can be broadcast to all indices via a gossip or similar mechanism (keeping the indices eventually consistent). Operations for Get can be broadcast to an individual index, thus enabling a large number of Get operations to be in flight at any time; it is expected that all such operations are accessible via an HTTP REST API, but other similar variations exist using differRPC and similar.

A document table 445 and a chunk table 450 are shown in FIG. 4D. The chunk table defines the component chunks for the document; all chunks comoprising a document have the same DocumentID; ChunkPosition is an ordinal which will be in the set {0 N} where N is the number of chunks into which the document is segmented.

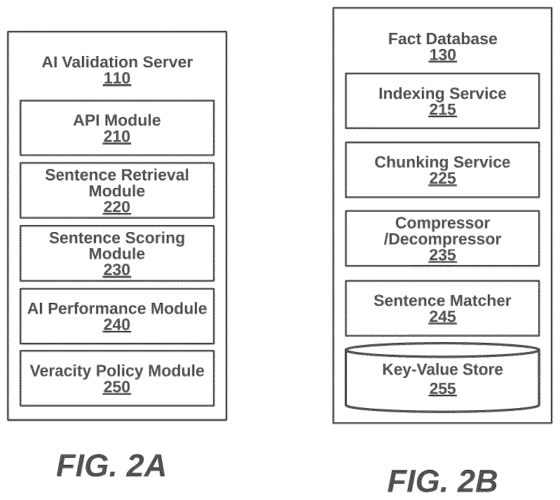

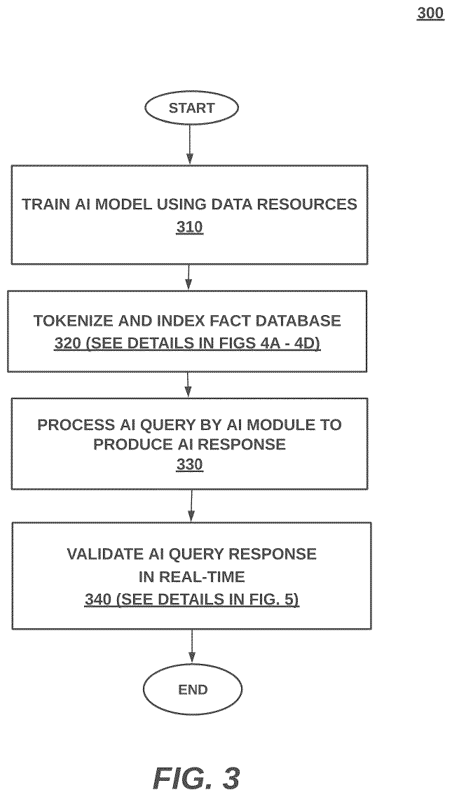

FIG. 2A is a more detailed illustration of AI validation server 110 of the system 100 of FIG. 1. The AI validation server 110 includes an API module 210, a sentence retrieval module 220, a sentence scoring module 230, an AI performance module 240 and a veracity policy module 250. The modules can be implemented in source code stored in non-transitory memory executed by a processor. Alternatively, the modules can be implemented in hardware with microcode. The modules can be singular or representative of functionality spread over multiple components. Many other variations are possible.

The API module 210 establishes communication protocols between AI query server 120 and validation processes. For example, a query service can be configured over a user interface or using command line interface (CLI) commands. In real-time operation, an API call can be received along with an utterance for validation. An API response can be transmitted including validation results.

The sentence retrieval module 220 locates candidate compression blocks in facts database 130 with similar words to those used in the utterances. Next, candidate sentences are located within compression blocks stored in the verification repository by scanning for sentences inside blocks. Some sentences may have all the large words while others have less. One optimization for processing a large number of candidate sentences is parallel scanning, using appropriate hardware. As a result, the candidate sentences have elementary word-level similarity to the original sentence. These sentences can have a superficial similarity to the original query response being validated. Although similar, there may be additional words like “not” that radically change the meaning of a sentence.

The sentence scoring module 230 compares candidate sentences with the original sentence, or query response, for evidence that sentences known to be correct supports or does not support the utterance. In one embodiment, a veracity score is produced from a number of comparisons. In one embodiment, a sentence scoring threshold is set as a standard for fact verification. The threshold can be static for all cases, or dynamically based upon context.

The AI performance module 240 optionally tracks AI agent performance over time. From this, training can be refined, analytics produced and visualizations created.

The veracity policy module 250 sets rules for handling scoring outcomes. For example, the utterance can be prevented from being transmitted to a user when below a predetermined threshold. Other rules can transmit the utterance with a veracity score or color-coded confidence level (e.g., green background for high confidence, yellow background for medium confidence and red background for low confidence).

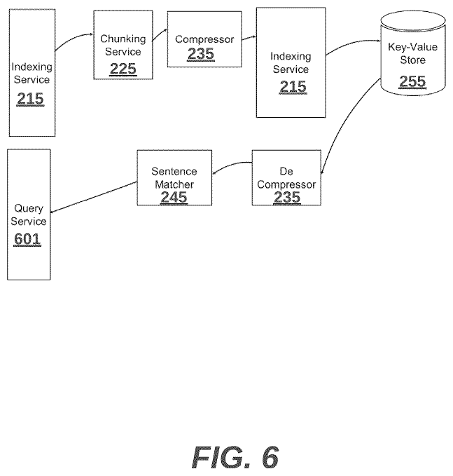

FIG. 2B is a more detailed illustration of fact database 110 of the system 100 of FIG. 1, according to an embodiment. In a forward flow, fact database 110 is trained from various resources, and in a reverse flow, fact database 110 is searched for specific sentences in AI applications, as shown in FIG. 6.

More specifically, in the forward flow, an indexing service 215 generates identifications for original documents, document chunks and words from chunks or from sentences. A chunking service 225 can break down documents and other resources into chunks. This allows more parallel-processing by standardizing data from different resources. A compressor/decompressor 235 tokenizes words using Kaggle or other definitions. The tokens are even more standardized than chunks and are stored in a key-value store 255.

In the reverse flow, key-value store 255 is sorted for specific words as directed by a sentence matcher 245. The tokens are sent back compressor/decompressor 235 to expose the raw data. Chunks can be reassembled via identifications in to raw documents.

II. Methods for Identifying Fact Hallucinations with Tokenized Databases

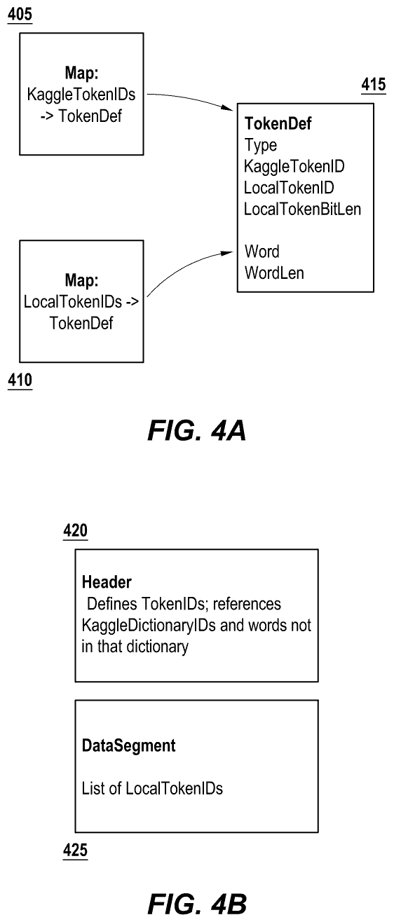

FIG. 3 is a high-level flow diagram illustrating a method for quality control for AI systems, according to one preferred embodiment. The method 300 can be implemented, for example, by the system 100 of FIG. 1. The steps are merely representative groupings of functionality, as there can be more or fewer steps, and the steps can be performed in different orders. Many other variations of the method 300 are possible.

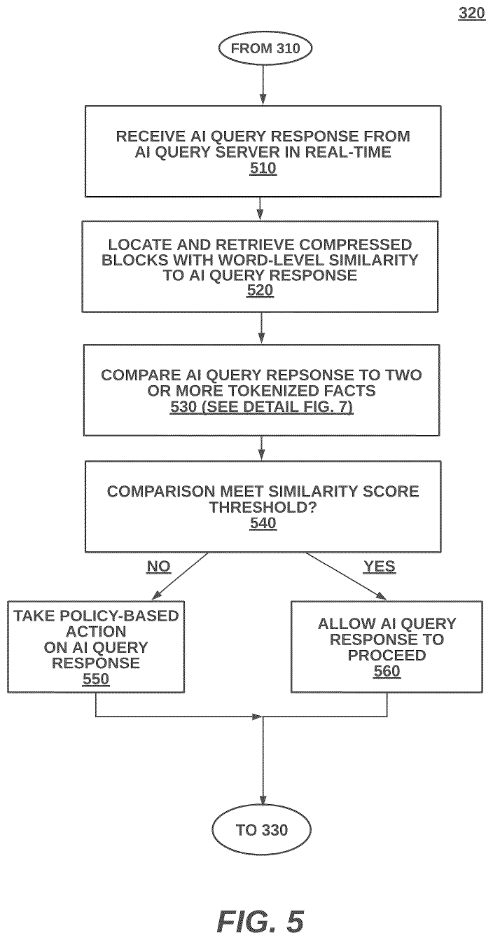

At step 310, an AI model is trained using data resources. At step 320, a fact database is tokenized and indexed. At step 330 an AI query is processed by an AI module using, for instance, a neural model as an input is received in real-time. At step 340, a real-time AI query response is validated, as described more fully below with respect to FIG. 5. The query response involves at least two facts. Further details to indexing the fact database are shown in FIGS. 4A-4D.

FIG. 5 is a more detailed flow diagram illustrating the step 340 for real-time identification of fact hallucinations in query results produced by AI, according to one embodiment.

At step 510, an AI query response is received in real-time.

At step 520, compressed blocks having word-level similarity to the AI query response are located and retrieved from a tokenized database, by tokenizing data of the AI query response.

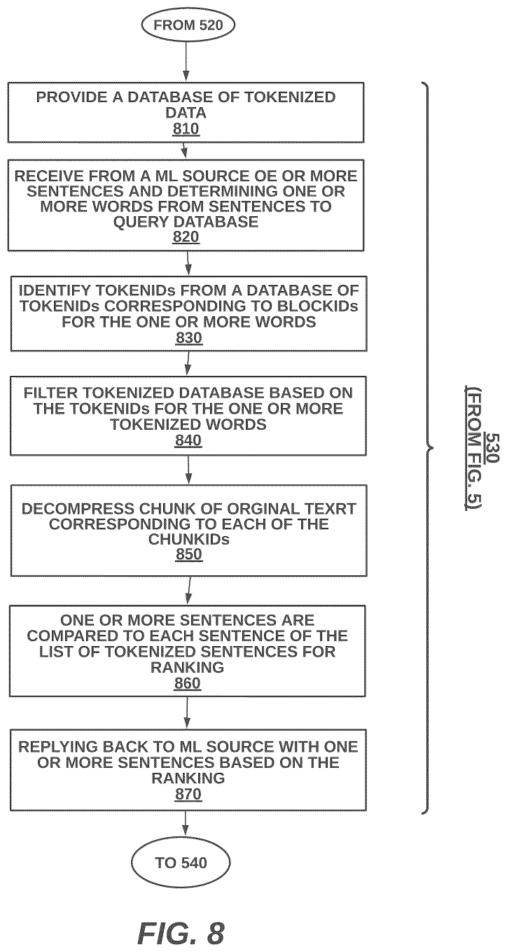

At step 530, the AI query response is compared to two or more tokenized facts of the compressed blocks at a data level, as shown in FIG. 8 and discussed below. In one embodiment, comparing includes computing a similarity score of a vector derived from the tokenized query response to one or more vectors derived from the one or more tokenized facts.

At step 540, an action is taken based on the validation step. More specifically, responsive to a verification result failing to meet a similarity score threshold, a policy-based action is taken on the AI query response, at step 550, and responsive to the verification result meeting the similarity threshold, the AI query response is allowed to proceed, at step 560.

In more detail, as shown in FIG. 6, an indexing service 215 divides raw data into blocks with a chunking service 225 before being compressed 235 and indexed in a key-value store 255. These chunks are quickly located by the key-value and decompressed 235 to words when used by for word-level, sentence matching 245 against AI query response received by query service 601.

The following is example definition of an API on the document retrieval service:
DocumentID getEnclosingDocumentID(ChunkID) Map<ChunkOrdinal, ChunkID> getSibilingChunks(ChunkID) Map<ChunkOrdinalChunkID> getChunksForDocument(DocumentID);
String getDocumentPlainText(DocumentID) String getChunkPlainText(ChunkID)
putCompressedChunk (ChunkID, CompressedChunk) CompressedChunk getCompressedChunk(ChunkID)
removeChunk(ChunkID) removeDocument(DocumentID);
   which in turn uses a key-value store to perform actual storage, and the DecompressionService to perform decompression.

The following is an example of Compression microcode:

Compresses chunks and documents—uses the ChunkingService to decompose documents into chunks
List<{Pair<ChunkID, CompressedChunk>}compressDocument(String) {ChunkID, CompressedChunk}compressChunk(String)

The following is an example of decomposing a document into chunks suitable for compression:
List<Chunk> getChunks(String))

FIG. 8 is a more detailed flow diagram illustrating the step 530 of comparing AI query response to tokenized facts, according to an embodiment.

At step 810, providing a database of tokenized data, wherein the tokenized database has been trained with a chunk of original text with words that have been compressed with tokens corresponding to the words. The text chunk is assigned a chunkID and at least some of the words are assigned a tokenID.

At step 820, receiving, from a ML source, one or more sentences, and determining one or more words from the one or more sentences to use for querying the tokenized database.

At step 830, identifying tokenIDs from a database of tokenIDs corresponding to the blockIDs for the one or more words from the one or more sentences. The tokenID database associates a list of blockIDs to tokenIDs of words using a fixed number of bytes. TokenIDs are limited in number based on the fixed number of bytes and assigned based at least in part on frequency of use.

At step 840, filtering the tokenized database based on the tokenIDs for the one or more tokenized words from the search query, wherein each tokenID exposes a list of blocksIDs.

At step 850, decompressing a chunk of original text corresponding to each of the chunkIDs.

At step 860, comparing the one or more sentences to each sentence of the list of tokenized sentences to rank sentences.

At step 870, replying, back to the ML source, one or more sentences based on the raking.

### III. Generic Computing Device

FIG. 7 is a block diagram illustrating an example computing device 700 for use in the system 100 of FIG. 1, according to one embodiment. The computing device 700 is implementable for each of the components of the system 100. The computing device 700 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 700, of the present embodiment, includes a memory 710, a processor 720, a storage drive 730, and an I/O port 740. Each of the components is coupled for electronic communication via a bus 799. Communication can be digital and/or analog and use any suitable protocol.

The memory 710 further comprises network applications 712 and an operating system 714. The network applications 712 can include a web browser, a mobile application, an application that uses networking, a remote application executing locally, a network protocol application, a network management application, a network routing application, or the like.

The operating system 714 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6, Windows 8 or Windows 10), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 720 can be a network processor (e.g., optimized for IEEE 802.11, IEEE 802.11AC or IEEE 802.11AX), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory 710 or the storage drive 730.

The storage drive 730 can be any non-volatile type of storage such as a magnetic disc, EEPROM (electronically erasable programmable read-only memory), Flash, or the like. The storage drive 730 stores code and data for applications.

The I/O port 740 further comprises a user interface 742 and a network interface 744. The user interface 742 can output to a display device and receive input from, for example, a keyboard. The network interface 744 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with AI.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A method, in a computer device, for tokenizing text for efficient searching by machine learning (ML) applications, the method comprising:
providing a database of tokenized data, wherein the tokenized database has been trained with a chunk of original text with words that have been compressed with tokens corresponding to the words, wherein the text chunk is assigned a chunkID and at least some of the words are assigned a tokenID;
receiving, from a ML source, one or more sentences, and determining one or more words from the one or more sentences to use for querying the tokenized database;
identifying tokenIDs from a database of tokenIDs corresponding to the blockIDs for the one or more words from the one or more sentences, wherein the tokenID database associates a list of blockIDs to tokenIDs of words using a fixed number of bytes, wherein tokenIDs are limited in number based on the fixed number of bytes and assigned based at least in part on frequency of use;
filtering the tokenized database based on the tokenIDs for the one or more tokenized words from the search query, wherein each tokenID exposes a list of blocksIDs;
decompressing a chunk of original text corresponding to each of the chunkIDs;
comparing the one or more sentences to each sentence of the list of tokenized sentences to rank sentences; and
replying, back to the ML source, one or more sentences based on the raking.

2. The method of claim 1, wherein tokenIDs correspond to Kaggle terms.

3. The method of claim 1, wherein tokenizing the query response comprises retrieving Kaggle tokenIDs associated with one or more words of the query response.

4. The method of claim 1, wherein the tokenizing one or more facts comprises Kaggle tokenIDs associated with one or more words of the one or more facts.

5. The method of claim 1, wherein comparing the one or more sentences to each sentence of the list of tokenized sentences comprises using a natural language processor (NLP) to determine similarity.

6. The method of claim 1, wherein the computer device is communicatively coupled to a data communication network.

7. The method of claim 1, wherein the computer device comprises an AI appliance.

8. The method of claim 1, wherein the computer device services a plurality of clients distributed over s data communication network.

9. A non-transitory computer-readable media in an artificial intelligence (AI) validation server, implemented at least partially in hardware, when executed by a processor, for tokenizing text for efficient searching by machine learning (ML) applications, the method comprising the steps of:
providing a database of tokenized data, wherein the tokenized database has been trained with a chunk of original text with words that have been compressed with tokens corresponding to the words, wherein the text chunk is assigned a chunkID and at least some of the words are assigned a tokenID;
receiving, from a ML source, one or more sentences, and determining one or more words from the one or more sentences to use for querying the tokenized database;
identifying tokenIDs from a database of tokenIDs corresponding to the blockIDs for the one or more words from the one or more sentences, wherein the tokenID database associates a list of blockIDs to tokenIDs of words using a fixed number of bytes, wherein tokenIDs are limited in number based on the fixed number of bytes and assigned based at least in part on frequency of use;
filtering the tokenized database based on the tokenIDs for the one or more tokenized words from the search query, wherein each tokenID exposes a list of blocksIDs;
decompressing a chunk of original text corresponding to each of the chunkIDs;
comparing the one or more sentences to each sentence of the list of tokenized sentences to rank sentences; and
replying, back to the ML source, one or more sentences based on the raking.

10. An artificial intelligence (AI) validation server, for tokenizing text for efficient searching by machine learning (ML) applications, the AI validation server:
a processor;
a network gateway communicatively coupled to the processor and to a data communication network; and
a memory communicatively coupled to the processor and storing modules, comprising:
a database API configured to provide a database of tokenized data, wherein the tokenized database has been trained with a chunk of original text with words that have been compressed with tokens corresponding to the words, wherein the text chunk is assigned a chunkID and at least some of the words are assigned a tokenID;
an input configured to receive, from a ML source, one or more sentences, and determining one or more words from the one or more sentences to use for querying the tokenized database;
a tokenID table configured to identify tokenIDs from a database of tokenIDs corresponding to the blockIDs for the one or more words from the one or more sentences, wherein the tokenID database associates a list of blockIDs to tokenIDs of words using a fixed number of bytes, wherein tokenIDs are limited in number based on the fixed number of bytes and assigned based at least in part on frequency of use;
a blokckID table configured to filter the tokenized database based on the tokenIDs for the one or more tokenized words from the search query, wherein each tokenID exposes a list of blocksIDs;
a decompression module configured to decompress a chunk of original text corresponding to each of the chunkIDs;
a sentence selector configured to compare the one or more sentences to each sentence of the list of tokenized sentences to rank sentences; and
an output configured to reply, back to the ML source, one or more sentences based on the raking.
